(19) United States
(12) Patent Application Publication
(10) Pub. No.: US 2019/0361986 A9
(43) Pub. Date: Nov. 28, 2019

(54) Method for displaying dynamic media with text bubble emulation

(71) Applicant: Scott Spaulding, Newburyport, MA (US)

(72) Inventor: Scott Spaulding, Newburyport, MA (US)

(21) Appl. No.: 14/998,754

(22) Filed: Feb. 11, 2016

Related U.S. Application Data
(60) Provisional application No. 62/176,254, filed on Feb. 12, 2015.

(51) Int. Cl. G06F 17/30; G06F 17/24

(52) U.S. Cl. CPC G06F 17/30058; G06F 17/24; G06F 17/3089

(57) ABSTRACT

A method for composing and displaying media on an electrical device in the manner of a comic strip utilizes an improvised text bubble, i.e. a bubble tail absent a bubble body, wherein said tail directs a user's attention from one media element to a separately tagged, adjacent media clement contained in an emulated bubble body, so that search, editing, interactivity, and dynamic capabilities of said element are enabled

### TECHNICAL FIELD

The present disclosure relates generally to computer networks, and more specifically to the composition, editing, and display of text, images, audio, and video on electronic display devices over a computer network.

### BACKGROUND INFORMATION

With the popularity of the internet, comic strips, like other mediums, have moved online, yet even with the availability of computer-assisted comic strip generation, and the ubiquity of computerized image editors, tradition still rules the day and text bubbles are displayed as image objects, as a part of a larger image. Subsequently, removing text bubbles from a comic image, and displaying a comic online, thus edited, without a text bubble body, but with a text bubble tail, has not occurred to anyone. Including a text bubble tail in a comic display absent a text bubble body, as a ‘disembodied tail’, has not occurred despite the disadvantages of including an entire text bubble image object in an image in a display. The present invention pays homage to traditional comic strip text bubbles, adjusted for the properties of online digital displays. The present method and system concerns excluding one or more whole text bubbles from a comic strip display and emulating text bubble bodies by placing disembodied text bubble tails in the display, and placing associated, tagged text next to a separately tagged image in the display, so that a comic strip is best presented on a variety of electronic display screens and formats, including in web pages, emails, and text messages.

Traditionally, when displaying a comic strip (i.e. comic) on a network-connected computer or mobile device, speech or thought attributable to a character is depicted with lettering inside of a text bubble (i.e. bubble). The bubble is displayed in an image with other image objects, such as a comic character (i.e. character), and the edges of an image are indicated by a border line, or by the edges of a display screen. A display screen can contain one or more such images. Typically, a text bubble consists of a rounded or rectangular shape (i.e. body) connected to a bubble tail (i.e. tail). A speech bubble tail is an elongated curved or straight, open-ended triangular shape, the closed point of which is located in close proximity to a speaking comic character. A thought bubble tail is typically a trail of small ovals graduating in size towards a speech bubble, with the smallest oval in close proximity to a character. Tails can take other forms, such as a straight line.

Where tails are small, bubbles are large, and often cover a large area of an image. Conversely, relative to an entire page of multiple comic strip images, a text bubble can appear small and hard to read, especially when displayed on a small screen such as on a mobile device.

Speech attributable to a character is sometimes displayed as a caption, with quotation marks, said caption displayed as an image; or as text. Either way, if lettering displayed in such a manner is not pointed to by a tail it can be difficult for users to distinguish it from narrative lettering or ‘voice-over’, or to identify which character is ‘speaking’. Plus, the look of a conventional comic is lost without a tail. In any comic strip display, or in any meme displayed in the manner of a conventional comic strip, the display is not perceived as a comic strip if one or more tails are not part of the display. Likewise, a clear relationship between characters and text is not established without a tail. A conventional look is not lost, however, if the lines of a bubble body are excluded from the display, and drawn lettering in a bubble body is likewise excluded, as long as a text bubble body is emulated in the display by means of careful placement and positioning of a disembodied tail in proximity to a character object in an image, with the other end of said tail in proximity to an element of tagged text, and the background color of said tagged text that the tail points to is matched with the color of the tail. In another embodiment, said text is visually bracketed using edges of the display screen, if possible, or by placing background colors in the display, outside of the comic image and it's associated text field, that contrast with the background color of the text field. In yet another embodiment, text bracketing is aided by using bubble body-part image files.

### SUMMARY

In the present invention, emulating a bubble body in a display instead of drawing it, placing the emulation outside of (i.e. separate from) images, and establishing a visual relationship between text and images using bubble tails, absent bubble bodies, encompasses a number of advantages.

An object and advantage of the present invention as it concerns searching and indexing a comic display, is as follows: displaying an image and text in the manner of a comic strip, in such a way that the display can be economically and accurately parsed and indexed, by tagging text related to a character object in the source code for the display, as well as in the display itself, but not displaying the text as part of an image, wherein text is composed using a broadly recognized mark-up language, such as html or html5, and not converted into an image. In prior art, once a bubble attributable to a comic character is converted into a image file for display on a network, editing words in the bubble involves drawing or generating a new image, even if text is interactively entered (i.e. input) in a display as text. When text inside of or on top of a bubble is displayed as an image, said text cannot be accurately and economically indexed and parsed by a search engine because it is an image. Typically, indexing and parsing a comic display is generally done using file names of images in the display, and image file names do not accurately or fully convey the subject matter of a comic strip or meme or graphic novel. Marking up text in display source code, as well as in a display itself, is essential for accurate indexing and searching of a comic strip or meme, especially when it contains an abundance of words, which comics and memes sometimes do, such as when they are used for news, informational, or educational purposes. If text interactively entered in a comic display is stored on a network server or, locally, in a cache, secondary to display page source code, before ultimately being converted into an image and displayed as an image, said text is not crawled and indexed by large scale search engines that crawl and index the internet. Text displayed according to the present invention can be crawled and indexed for search, and foreign language translation of said text utilizing an online language translator is also enabled, something that is not possible if text is displayed as an image. The present invention accommodates the size and universality of the internet, and search engines and foreign language users that access a webpage display. Furthermore, computer-generated audio recordings of comic strips, graphic novels, and text is enabled when text in a display is not converted into an image, and is marked up in source code for the display.

Yet another object and advantage of the present invention as it concerns visibility of comic displays, is as follows: maintaining the look and manner of a conventional comic strip in a display in which one or more text bubble bodies has been excluded while maintaining an unobstructed and efficient view of the display, accomplished by including one or more deliberately placed disembodied text bubble tails in the display, with a separately tagged media element, such as text, wherein associated images are not blocked by a bubble body. More and more, the internet is being accessed via a small touch screen, such as a smart phone or smart watch screen, wherein a conventional comic or meme is viewed on a small display screen, and wherein lettering in a bubble is too small for a user to read without enlarging, pinching and swiping the display numerous times, sometimes temporarily forcing large areas of an image off the display screen, which is frustrating for the user. In a conventional comic display, a bubble is often granted a small footprint relative to the entirety of images in a display, such that lettering in the bubble is too small to read. If, in order to counter this effect, an edited enlargement of a text bubble is generated and layered over a displayed image a user's view of the underlying image is subsequently compromised, if only temporarily, and a newly generated image with a size-reduced bubble, or no bubble, must nonetheless be drawn and displayed, and the user must engage in extra inputs such as scrolling, swiping, and pinching. When marked up text is displayed separately as a text element next to an image element, the user's view of an image is not significantly blocked, and the text's font size can be triggered according to the type and size of the display device, said automation dictated by scripts in the mark-up code for the display. Furthermore, the present invention allows for more economical use of display screen real estate by enabling a one word or one-phrase tagged advertisement link embedded in a text field (i.e. in a bubble emulation), in lieu of a non-imbedded display ad. Hyperlinked ads imbedded in text are not possible if said text is an image. In the present invention, imbedding a link to a network resource, such as to an advertisement, in text, does not require editing of an image in a comic display, and segments of network feeds that are part of a display or part of text in an emulated bubble, can be dynamically generated and changed on the fly, e.g. in real time. Another advantage of the present invention is that an artist drawing an image to be part of a comic strip display doesn't need to worry about leaving a region of a drawing object-free in anticipation of placing a bubble body in said region later on. The same artist doesn't need to worry about allowing a region of an image to be clear of image objects in anticipation of placing a tail object in the image, because tails are tiny, relative to real estate in an image, and relative to real estate in a display. In a related embodiment of the present invention, tagged text is displayed with a disembodied tail on top of an imago containing a character object, said image tagged as a background image in the display, wherein said text is nevertheless not converted, itself, into an image.

Yet another object and advantage of the present invention is as follows, and it concerns a user, or multiple users, interacting with a comic display, including displays comprised of a variety of media. As more and more comics have been posted to the internet, and online image editing software has become cheaper, easier to use, and more accessible to users, text bubbles attributable to a character have been added to photographic images, and to video displays. Adding text bubbles to photographs and other media is an ‘internet-born’ re-interpretation of conventional comic strips, known as memes. The present invention encompasses such memes, as well as conventional comic strips and graphic novels, and it encompasses displays of sequential media segments displayed with a horizontal, as well as a vertical, orientation, wherein horizontal, as well as vertical, swiping and scrolling are utilized as inputs, and wherein alternative methods of inputs are used, including voice and gesture recognition. According to the present invention, by including a disembodied tail and tagging text in a display, any drawing or photograph can quickly and economically be displayed in the manner of a comic strip, in a web page, email, or text message, by a single user, or by any number of unskilled, designated users. Text in a display, as well as images accompanying a text bubble emulation in a display, can be singularly edited when said text or images are tagged and displayed independently of one another in the display, and multi-media displays of text, imagery, video, and hyperlinked advertisements displayed in the manner of a traditional comic strip are therein efficiently created or edited, simultaneously and in real time, by a multitude of designated users, when one or more text fields, and one or more images containing a character object related to a text field, are tagged and displayed independently of one another. By the same manner, in the present invention an image or video thumb displayed amongst comic strip segments can be edited or replaced or removed independently of other segments in the display, and segmented displays of text, imagery, and advertisements displayed in the manner of a traditional comic strip can be edited independently of other segments in a display. A greater degree of labor and specialized skill is required in the drawing and editing of a comic strip image or meme image, generally speaking, than is required in the writing and editing of a snippet of text. Utilizing a disembodied tail, the present invention accommodates this imbalance as it pertains to composing a comic strip or meme display, including in an interactive format involving participation by a crowd of unskilled users, by enabling text to be input and edited without necessitating editing of an image associated with that text, and enabling singular editing of other media elements in the display. In a related embodiment, a comic strip or meme displayed over a social network is crowd sourced, wherein trending media elements or portions of text in a display reflect a consensus choice, or opinion, of a group of participating users. In yet another embodiment, advertisements are inserted or fed in a display which reflect the subject matter of said display, or reflect specific interests, or stored data, related to a user accessing the display. Processing said subject matter data and stored interest data is enabled by the parsing and indexing properties of the present invention described above. Only one or more text bubble bodies in a display need be excluded and replaced by tagged text accompanied by a disembodied tail, in order for a display to embody the editing, indexing, visibility, and interactive advantages of the present invention. If textual display ads not imbedded in text bubble emulations are desired, tagging and segmentation of a comic strip display or meme display as it is described above enables non-imbedded display ads to be efficiently added to a display, including in place of text in an emulated bubble, wherein all manner of hyper-linked media elements can be singularly input and displayed in-between tagged segments of a display without necessitating editing of other segments of the display. The present invention is embodied in a single-image, single text bubble emulation display, as well as in a multi-media display of multiple segments of text, drawings, photos, video, and advertisements displayed in the manner of a traditional comic strip.

A method and system is presented for displaying comic strips and memes over a digital network on an electronic display screen wherein text is displayed outside (i.e. separate from) one or more image elements containing a character, such that said image is viewed without interruption, and such that tagged text is part of the source code for the display, as well as part of the visual display itself, and the display is accurately and economically edited, indexed, and searched, and the look of a conventional comic strip is maintained utilizing the inclusion in the display of one or more disembodied text bubble tails, instead of whole text bubbles, wherein one or more text bubble bodies is emulated, not drawn, through deliberate positioning of said tails relative to text and relative to a character in the display, and through the matching of the color of a tail with the background color of tagged text that the tail ‘points’ to, wherein a lettering image object attributable to a comic character is not generated, and wherein not all text in a display is converted into an image, and wherein text is differentiated from being a caption by the inclusion of a disembodied tail directing a users gaze from a character object to a region of text displayed above, below, or to the side of an image. In displays where, for example, some lettering in a display is an image, enclosed in drawn bubbles, and some bubbles are emulated, without bubble bodies, using disembodied tails (i.e. wherein some text is included in source code for the display, as well as in the display itself), and wherein some bubbles are interactively generated as text but converted for display into an image, and wherein html, xhtm1, html5, css, css3, php, java or another screen mark up language is tagged for at least one text element in a display, the present invention is likewise embodied, whether the display is a comic, meme, or graphic novel and whether the display reports, educates, informs, advertises, or just entertains.

In summary, wherein a text bubble tail is a ‘signature’ of a conventional comic strip, a disembodied text bubble tail is a signature of the present invention.

BRIEF DESCRIPTION OF THE DRAWINGS

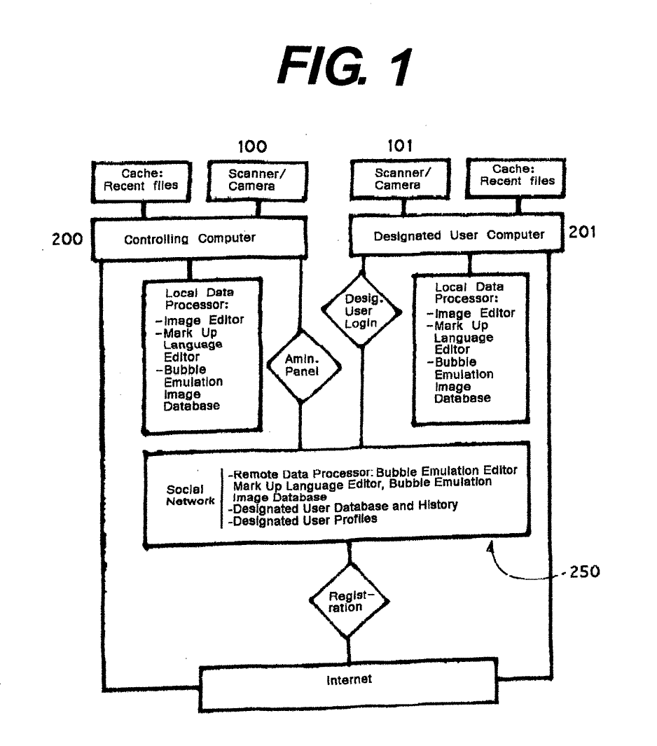

FIG. 1 is a block diagram of a text bubble emulation comic and meme network.

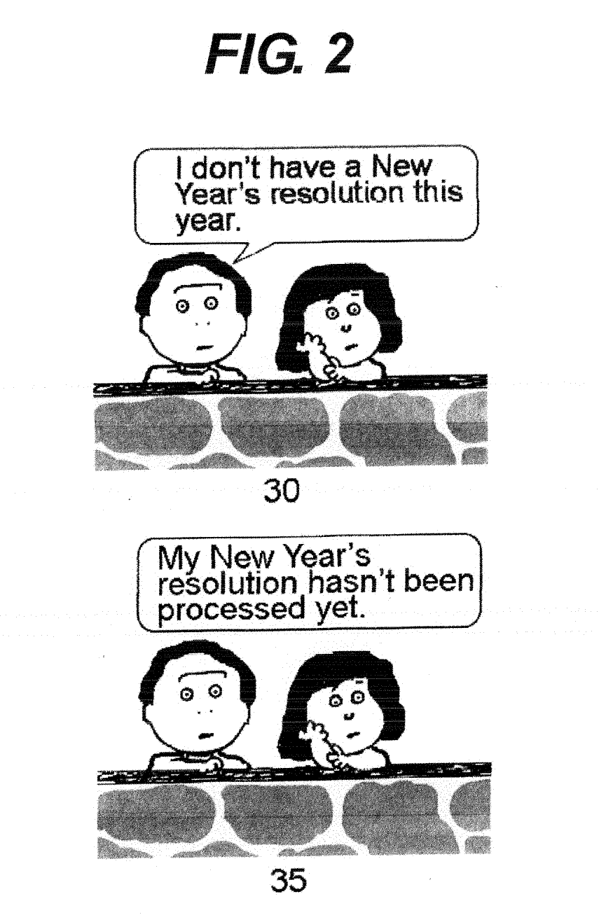

FIG. 2 is an illustration that demonstrates the necessity of a text bubble tail in a comic strip.

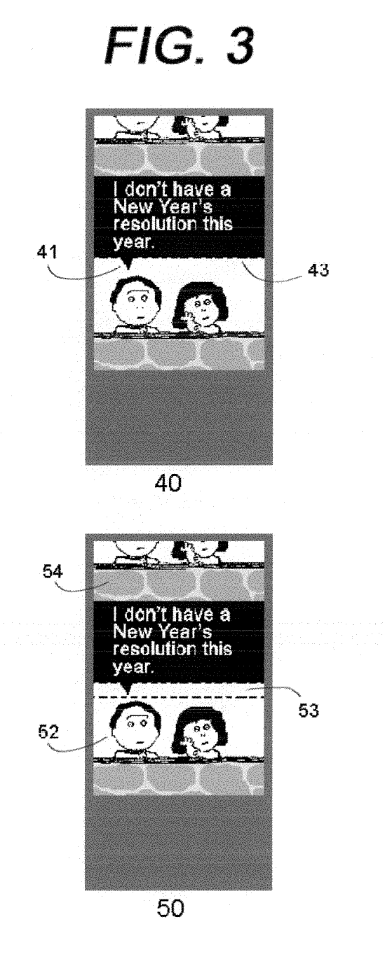

FIG. 3 illustrates two different displays with disembodied tail images inserted.

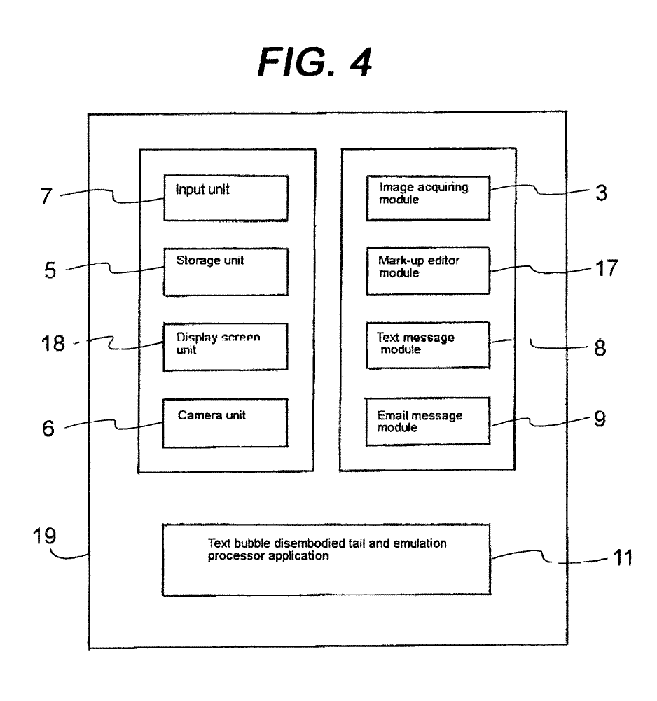

FIG. 4 is a block diagram of a text bubble emulation application on a mobile device.

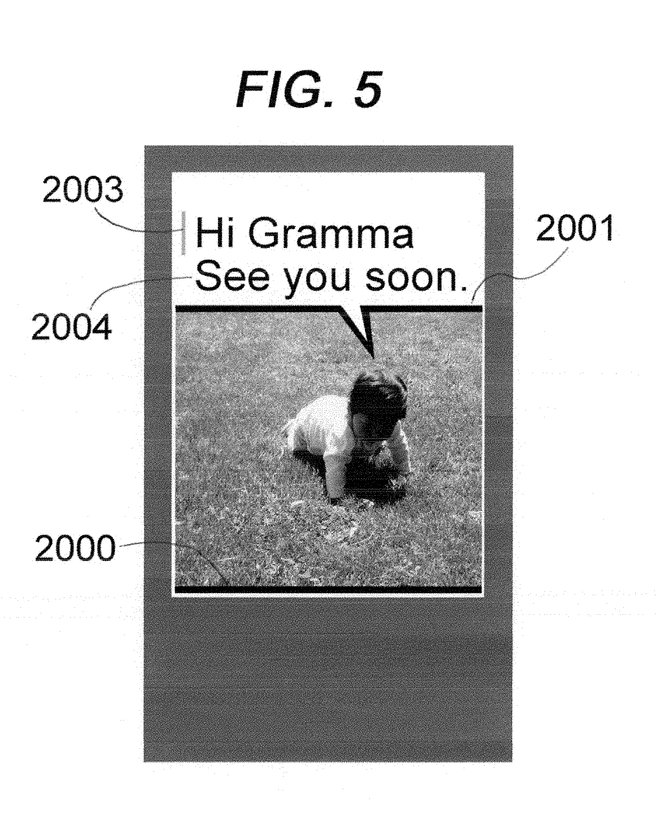

FIG. 5 illustrates a photo, text and disembodied tail display processed by a text bubble emulation application.

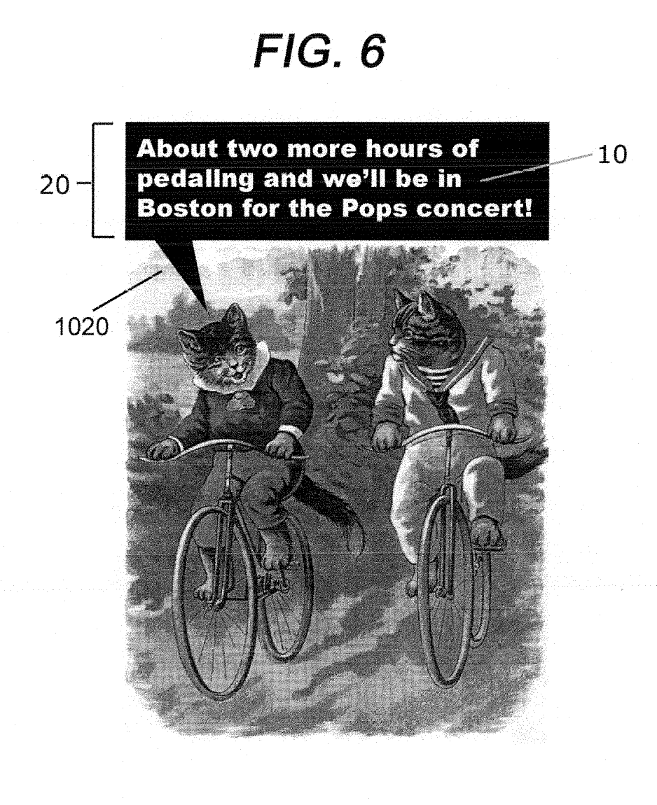

FIG. 6 is an illustration of a graphic novel page displayed with a disembodied tail and a text bubble emulation.

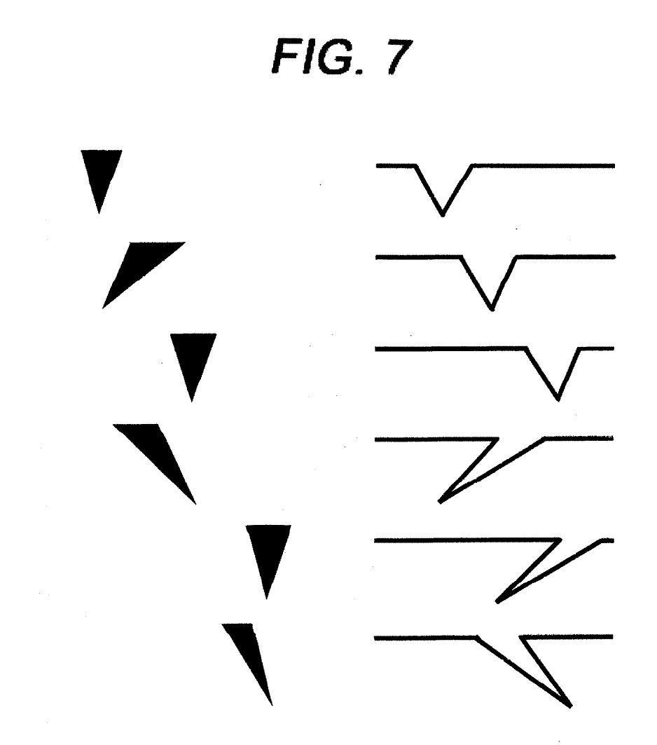

FIG. 7 is an exemplary diagram of a database of disembodied tail images.

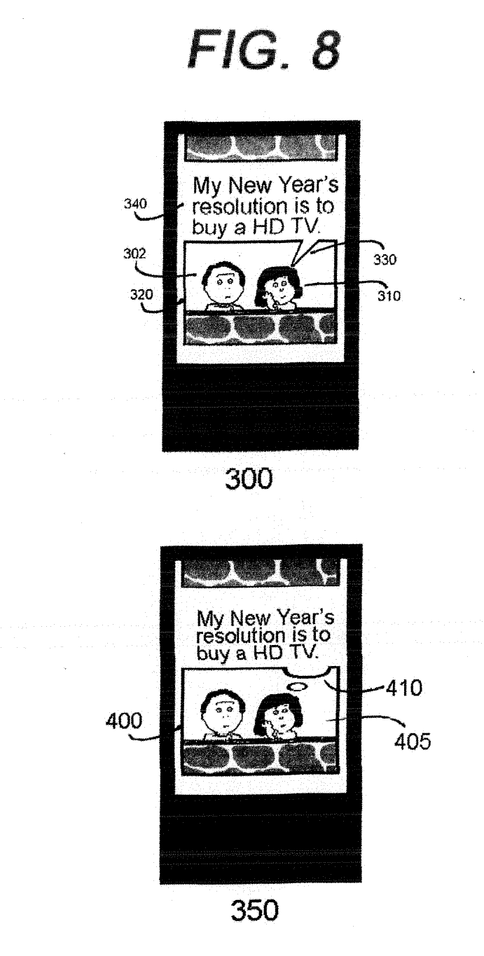

FIG. 8 is an illustration of disembodied tails drawn at the top edge of an image in a comic display.

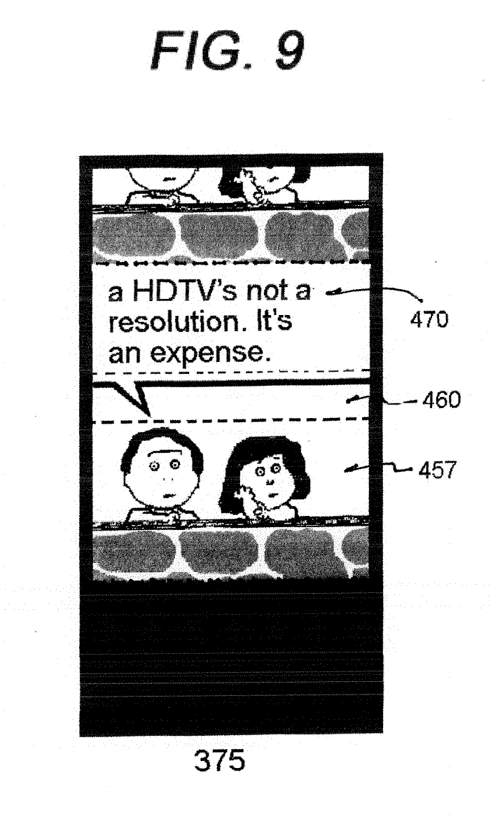

FIG. 9 is an illustration of a disembodied tail image displayed above a comic image, beneath tagged text.

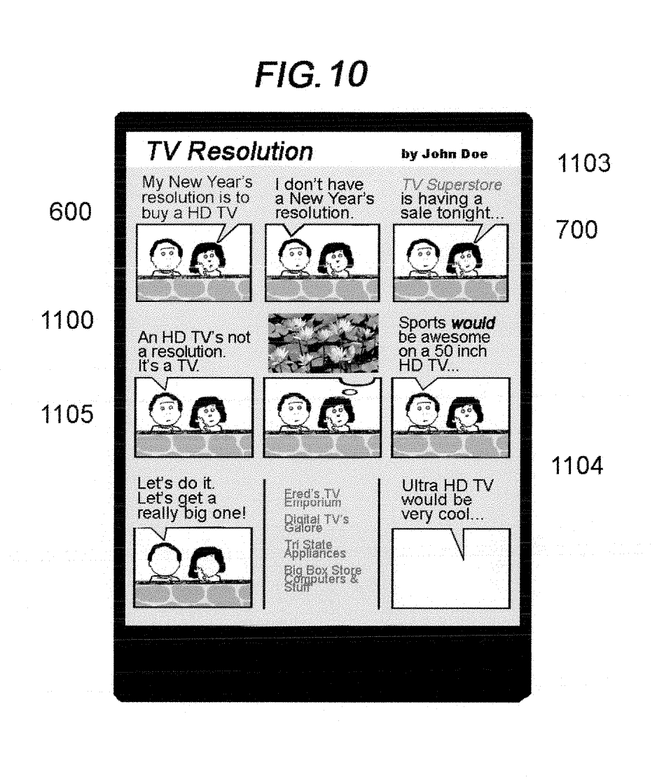

FIG. 10 is a segmented multimedia display with disembodied tails, emulated text bubbles, a video feed, and imbedded and non-imbedded links to a network resource.

### DETAILED DESCRIPTION

Referring to FIG. 1, an embodiment of the present invention, being a system for generating text-based comics, or editing image-based comics to become text based comics, includes a scanner or camera 100, 101 for creating digital images of drawings; a computer 200, 201 containing image editing software, or having remote access to an enhanced image editor 250 (i.e. Remote Text Bubble Tail and Emulation Processing Application), for removing text bubble objects and caption objects from digital images, cropping images, and drawing tails in images; said computer 200, 201 also containing a desktop html or other mark-up language editor for generating text bubble emulations and composing a comic strip or meme, including text, for display, or having remote access to a html or other mark-up language editor 250; said computer 200, 201 also containing a local database, or having remote access to a database 250, said database consisting of image files of various sizes, types, colors, and styles of tails and bubble body parts, for generating a comic strip or meme display out of a image and said database tail image, and text, for display over the internet. It is assumed scanner 100 is networked with computer 200, 201, and computer 200, 201 is part of a network that includes a server, or cloud, wherein comic strips and memes generated by computer 200, 201 and displayed over the internet are also stored on said server or cloud, where they can be retrieved from storage in real time simultaneously for further editing by computer 200, 201 or by any number of designated user computers in a social or messaging network, and wherein said comic strips and memes can also be temporarily locally stored in a cache, and wherein said comic strips and memes can be accessed and displayed over the Internet simultaneously and in real time by any number of designated users.

Referring to FIG. 2, Illustration 30; in a comic strip image containing two characters and a speech bubble, a tail attached to a bubble establishes a relationship between a bubble and a character such that said character (on the right in the Illustration) is clearly a speaking character. In Illustration 35, identical to Illustration 30 accept that a tail has been removed from a bubble so that a tail is not attached to a bubble in the image, wherein a speaking character is no longer established, as a demonstration of the essential nature of a tail in a conventional comic strip (or meme) display. In FIG. 2A, Illustration 40, a display is edited according to the present invention wherein a drawn bubble, drawn lettering, and drawn tail is removed from a image using a image editor, and a new tail 41 is drawn, with a side of tail 41 falling along a edge 43 of said image. Directly above said edge, text 57 is displayed, in emulation of a text bubble body, background color of said text being the same as fill color of tail 41, said text included in source code for said display, as well as visually in said display. In Illustration 50, a display edited such that, instead of a new tail drawn at a edge of a image 52, a image of a tail 53 (top and bottom edge of tail image 53 indicated by broken lines in the Illustration), from a database of tail images, is displayed above a image containing two character objects, wherein said image (with character objects) is cropped horizontally using a image editor, with text displayed above said tail image 53, said text included in display source code, as well as in said display. Additionally, in Illustration 50, a vertically displayed sequential comic strip such that a image 54, directly above and preceding a text bubble emulated according to the present invention, displayed above a tail image 53, in a display screen with vertically enabled scrolling, fully displayed image 52 one of several sequential images representing sequential moments in time in a comic strip or multimedia display comprised of one or more text fields (i.e. bubble emulations) and two or more images, text included in source code, as well as in said display.

Referring to FIG. 3, in another embodiment of the present invention a new tail 41 is transparent, layered or displayed on top of said image (or vice versa) so that a portion of said image is not entirely blocked by said new tail (or vice versa.)

Referring to FIG. 4, in an embodiment of the present invention, a computerized communication mobile device 19 (i.e. a smart phone), with an image acquiring module 3 designed to acquire images from a storage unit 5, said images consisting of user photographs recorded by a camera unit 6, or said images downloaded to said storage module from a network, including from a text message module 8, or from an email message module 9. In response to a user input from an input unit 7, said input unit a keypad or touch screen, a copy of an image acquired from said storage is displayed (as a raster image) on a display screen unit 18 according to instructions from a mark up editor module 17, and a point on said image is input by a user wherein said user taps twice, in quick succession, on a screen location above, and in close proximity to, the head of a character object in the image, wherein the X,Y coordinate of the second tap is processed in a Text Bubble Tail and Emulation Processing Application 11, wherein said application executes a crop of the image, thereby removing the entire region of the image above said Y coordinate, and draws at the top of the cropped image a white, or black, upside down triangular image object (i.e. disembodied speech bubble tail) such that the shortest side of the triangle rests along the top edge of the cropped image, and wherein the location of the closed corner of the triangle corresponds to said temporarily stored X, Y coordinate, said stored coordinate having been processed in the Emulation Application according to the following formula: coordinate=X,Y-10 pixels.

Referring to FIG. 5: in response to a further input from the input unit, a copy of the edited image is saved to the storage module and a reduced-height copy of the image is displayed on the display screen with a blinking cursor 2003 displayed just above said image, and text 2004 input by the user is displayed at the cursor above the image such that the resulting display acquires the manner of a comic strip display wherein the text is tagged in the source code for the display, and the background color of the text and fill color of the tail in the display is white. In response to further input by user said Emulation Application draws a straight black line 2000 along the bottom edge of the image. In response to further input said Emulation Application draws a black line 2001 along the top edge of the image, said line a continuous line that follows the image's edited top edge, including the two longest sides of the triangle. The resulting processed comic strip or meme is sent over an email or text message network in response to further user inputs and saved in the storage unit.

Referring to FIG. 6, a page of a graphic novel displayed on a computer network device screen according to the present invention; text 10, in an emulated text bubble 20, said text included (i.e. tagged) in source code for said display, as well as visually in said display itself; a disembodied tail image object 1040 drawn at the top of the image.

Referring to FIG. 7, exemplary image files in a database comprised of various sizes, types, colors, and styles of disembodied bubble tails, and bubble body parts, for inclusion in a display according to the present invention. (Note: FIG. 5 is exemplary and partial and, in this example, only has tail images in it. An actual database might have a greater number of images, including bubble body-part images, in it.)

Referring to FIG. 8 Illustration 300, another embodiment of the present invention: in an image 302 a speaking character 310 is enclosed in a line border 320 drawn in the shape, generally, of a square or a rectangle, coloring of said line in contrast to a white, or light, background color in a display screen, and coloring of said line in contrast to a generally white, or light, region of negative space in said image, said border with an indentation 330 in the shape of a triangle, depicting a speech tail, erased side of said triangle along a line border 320, such that a relationship between a speaking character 310 in a image in a display, and text in said display, is established. Above an indentation 330 in said display, a text bubble emulation 340, according to the present invention, said text included in source code for said display, as well as in said display itself. Illustration 350: an image 405 enclosed in a line border 400 drawn in the shape, generally, of a square or of a rectangle, coloring of said line in contrast to a generally white, or light, background color in said display screen, and coloring of said line in contrast to a generally white, or light, region of negative space in said image, said border with an indentation 410 in the shape of a partially erased oval, said oval the last oval in a progression of oval objects in said image, depicting a thought tail; said indentation 410 positioned in a line border 400, such that a relationship between a thinking character in said image in said display, and text in said display, is established; text included in source code for said display, as well as in said display itself.

Referring to FIG. 9, Illustration 375: image 457 in a display, beneath a tail image 460 in said display, a text bubble emulation 470 above tail image 460 in said display; text included in source code for the display as well as in said display itself. (Note: edges of tagged image files in Illustration 375 are indicated by broken lines.)

Referring to FIG. 10, a segmented, multimedia display including at least one disembodied tail 700, and at least one tagged text bubble emulation 600, according to the present invention. Also included: a tagged video-thumb feed 1100 associated with a thinking character as indicated by a disembodied thought bubble tail. Also included: a text-imbedded hyperlink 1103 to a network advertisement or informational source. Also included: non-imbedded hyperlinks 1104 to a network advertisement or informational source. Also included: an emulation bracket 1105 comprised of a tagged background color that contrasts with the lighter background color of tagged text and images on either side of it. Although the present invention has been described with reference to particular embodiments, those contained therein are exemplary, for the purpose of illustrating the invention, and various changes or modifications to those embodiments may be made without departing from the scope and spirit of the present invention.

1. A system and method for displaying, editing, searching, and interacting with multimedia comic strips, memes, and graphic novels on any of a variety of electronic device display screens comprising:
including separately tagged media elements, such as text, in source code, e.g. hypertext mark-up language for a display, as well as visually in the display itself
establishing a time synchronized relationship between a [text element or] media element in a display, and a specific character object in an adjacent image in the display, by means of a disembodied text bubble tail image object in the display, wherein editing, searching, language translation, hyper-linking, and interactive capabilities of said element, despite being displayed in the manner of a conventional comic strip, are enabled.

2. The method of 1 further comprising a time synchronized relationship between a character image object and a separately tagged adjacent video element is established by means of intentionally drawing a gesture or direct gaze on the part of said character in the exclusive direction of said adjacent video element, wherein a user's attention is directed from said character object to said adjacent video element, and wherein editing, searching, language translation, hyper-linking, and interactive capabilities of said video element, despite being displayed in the manner of a conventional comic strip, are enabled.

3. The method of 1 further comprising a time synchronized relationship between a character image object and a separately tagged adjacent gif element is established by means of intentionally drawing a gesture or direct gaze on the part of said character in the exclusive direction of said adjacent gif element, wherein a user's attention is directed from said character object to said adjacent gif element, and wherein editing, searching, language translation, hyper-linking, and interactive capabilities of said gif element, despite being displayed in the manner of a conventional comic strip, are enabled.

4. A multi-media composition of adjacent, separately tagged media elements on display screen contains at least one grouping, i.e. panel, of two or more media elements that portray the same moment in time, said time relationship established by a speech or thought bubble tail image object, absent a bubble body, located in one element, directing a user's attention toward a separate, adjacent media element.

5. The method of 4 wherein the background color of the elements and the fill color of the bubble tail image object match, or otherwise appear uniform, such that the appearance of a conventional comic strip is established.

6. A comic panel composed according to the method of 4 is converted into a single media element composition and sent or displayed over a computer network.

7. A comic panel composed according to the method of 4 is converted into a single media element composition and sent or displayed over a computer network, and printed onto paper.

8. A comic panel composed according to the method of 4 is transformed into a composition containing a lesser number of separate media elements and sent or displayed over a computer network.

9. A comic strip composed on an electrical device consists of one or more disembodied tails adjacent to an emulated bubble wherein a relationship between an image and a text field or an image and an image is established.
